(19) United States
(12) Patent Application Publication
(10) Pub. No.: US 2023/0156528 A1
(43) Pub. Date: May 18, 2023

(54) HANDOVER PROCESSING METHOD AND SOURCE BASE STATION

(71) Applicant: VIVO MOBILE COMMUNICATION CO., LTD., Dongguan (CN)

(72) Inventors: Yanxia ZHANG, Dongguan (CN); Zhenhua XIE, Dongguan (CN)

(73) Assignee: VIVO MOBILE COMMUNICATION CO., LTD., Dongguan (CN)

(21) Appl. No.: 18/154,898

(22) Filed: Jan. 16, 2023

Related U.S. Application Data
(63) Continuation of application No. PCT/CN21/08991, filed on Jul. 28, 2021.

(30) Foreign Application Priority Data
Jul. 30, 2020 (CN) 202010754578.1

(51) Int. Cl. H04W 36/00; H04W 36/22

(52) U.S. Cl. CPC H04W 36/0007; H04W 36/0061; H04W 36/22

(57) ABSTRACT

A handover processing method includes: providing multicast service information to a target base station based on target information of the target base station; where the target information includes at least one of following: base station type, supported service information, unsupported service information, or load information.

### CROSS-REFERENCE TO RELATED APPLICATION

This application is a Bypass Continuation Application of PCT/CN2021/108991 filed on Jul. 28, 2021, which claims priority to Chinese Patent Application No. 202010754578.1 filed on Jul. 30, 2020, which are incorporated herein by reference in their entirety.

### TECHNICAL FIELD

The present disclosure belongs to the field of communication technologies, and in particular, relates to a handover processing method and a source base station.

### BACKGROUND

With the development of communication technologies, the transmission of unicast services and multicast services is usually supported in communication information. In the process of multicast service transmission, if cell handover occurs, the multicast service being received by the terminal is easily interrupted. Therefore, in the existing technology, cell handover leads to poor continuity of the multicast service.

### SUMMARY

In a first aspect, a handover processing method is provided, performed by a source base station and including:

providing multicast service information to a target base station based on target information of the target base station;

where the target information includes at least one of the following: a base station type, supported service information, unsupported service information, or load information.

In a second aspect, a handover processing apparatus is provided, including:

a sending module, configured to provide multicast service information to a target base station based on target information of the target base station;

where the target information includes at least one of the following: a base station type, supported service information, unsupported service information, or load information.

In a third aspect, a source base station is provided, including a processor, a memory, and programs or instructions stored in the memory and executable on the processor, where the programs or the instructions, when executed by the processor, implement the steps of the method according to the first aspect.

According to a fourth aspect, a non-transitory readable storage medium is provided. The non-transitory readable storage medium stores a program or an instruction, and when the program or the instruction is executed by a processor, the steps of the method according to the first aspect are implemented.

In a fifth aspect, an embodiment of the present disclosure provides a chip, including a processor and a communication interface, where the communication interface is coupled to the processor, and the processor is configured to execute programs or instructions of a network device to implement the steps of the method according to the first aspect.

### BRIEF DESCRIPTION OF DRAWINGS

FIG. 1 is a structural diagram of a network system to which an embodiment of the present disclosure may be applied;

FIG. 2 is a flowchart 1 of a handover processing method provided by an embodiment of the present disclosure;

FIG. 3 is a flowchart 2 of a handover processing method provided by an embodiment of the present disclosure;

FIG. 4 is a flowchart 3 of a handover processing method provided by an embodiment of the present disclosure;

FIG. 5 is a structural diagram of a handover processing apparatus provided by an embodiment of the present disclosure;

FIG. 6 is a structural diagram of a communications device provided by an embodiment of the present disclosure; and

FIG. 7 is a structural diagram of a source base station provided by an embodiment of the present disclosure.

### DESCRIPTION OF EMBODIMENTS

The following clearly describes the technical solutions in the embodiments of the present disclosure with reference to the accompanying drawings in the embodiments of the present disclosure. Apparently, the described embodiments are some but not all of the embodiments of the present disclosure. All other embodiments obtained by a person of ordinary skill in the art based on the embodiments of the present disclosure shall fall within the protection scope of the present disclosure.

The terms “first”, “second”, and the like in the specification and claims of the present disclosure are used to distinguish between similar objects instead of describing a specific order or sequence. It should be understood that, data termed in such a way is interchangeable in proper circumstances, so that the embodiments of the present disclosure can be implemented in an order other than the order illustrated or described herein. Objects classified by “first” and “second” are usually of a same type, and the number of objects is not limited. For example, there may be one or more first objects. In addition, in the specification and the claims, “and/or” represents at least one of connected objects, and the character “/” generally represents an “or” relationship between associated objects.

It should be noted that the technology described in the embodiments of the present disclosure is not limited to a Long Term Evolution (LTE)/LTE-Advanced (LTE-A) system, and may also be used in other wireless communications systems such as Code Division Multiple Access (CDMA), Time Division Multiple Access (TDMA), Frequency Division Multiple Access (FDMA), Orthogonal Frequency Division Multiple Access (OFDMA), Single-carrier Frequency-Division Multiple Access (SC-FDMA), and another system. The terms “system” and “network” in the embodiments of the present disclosure may be used interchangeably. The technologies described can be applied to both the systems and the radio technologies mentioned above as well as to other systems and radio technologies. However, a new radio (NR) system is described in the following description for illustrative purposes, and the NR terminology is used in most of the following description, although these technologies can also be applied to applications other than the NR system application, such as the 6-th generation (6G) communication system.

FIG. 1 is a block diagram of a wireless communications system to which embodiments of the present disclosure can be applied. The wireless communications system includes a terminal 11 and a network side device 12. The terminal 11 may also be referred to as a terminal device or user equipment (UE). The terminal 11 may be a terminal side device such as a mobile phone, a tablet personal computer, or a laptop computer, or called a notebook computer, a personal digital assistant (PDA), a palmtop computer, a netbook, an ultra mobile personal computer (UMPC), a mobile internet device (MID), a wearable device, a vehicle user equipment (VUE), or a pedestrian user equipment (PUE). The wearable device includes bracelets, headphones, glasses, etc. It should be noted that a type of the terminal 11 is not limited in the embodiments of the present disclosure. The network side device 12 may be a base station or a core network device, and the base station may be referred to as a NodeB, an evolved NodeB, an access point, a base transceiver station (BTS), a radio base station, a radio transceiver, a basic service set (BSS), an extended service set (ESS), a NodeB, an evolved NodeB (eNB), a home NodeB, a home evolved NodeB, a WLAN access point, a WiFi node, a transmitting receiving point (TRP), or another appropriate term in the art. Provided that the same technical effect is achieved, the base station is not limited to technical vocabulary. It should be noted that the base station in an NR system is merely used as an example, but a type of the base station is not limited in the embodiments of the present disclosure.

For ease of description, the following describes some content in the embodiments of the present disclosure:

A multimedia broadcast multicast service (MBMS) is hereinafter referred to as a multicast service.

In an LTE system, multicast services can be implemented in two manners of multicast broadcast single frequency network (MBSFN) and single-cell point-to-multipoint (SC-PTM).

1. MBSFN manner: equivalent to receiving the same data through multiple paths. Transmission is performed through a physical multicast channel (PMCH) in an MBSFN subframe. Control information and data information of the MBMS service are sent in a broadcast manner, so that both the idle UE and the connected UE can receive the MBMS service, and the data information of the MBMS is only sent in the MBSFN subframe. The control information related to the multicast service is sent through system information and a multicast control channel MCCH), and the data is sent through a multicast traffic channel (MTCH). The control information of the MBMS service may include control channel parameters, service channel parameters, scheduling information, etc., and the control information may be sent in a system information block (SIB) 13.

2. SC-PTM manner: transmission through a physical downlink shared channel (PDSCH) scheduled by a physical downlink control channel (PDCCH). Control information is sent through system information (such as SIB20) and a single cell multicast control channel (SC-MCCH), and data is sent through a single cell multicast traffic channel (SC-MTCH). The SC-MCCH is sent through a PDSCH scheduled by an SC radio network temporary identity (SC-RNTI) PDCCH, and the SC-MTCH is scheduled through a PDSCH scheduled by a group radio network temporary identity (G-RNTI) PDCCH.

In the new radio (NR), it is expected to support the continuity of multicast service data during cell handover. Therefore, the handover processing method of the present disclosure is proposed. Cell handover can be understood as mobile handover.

The handover processing method provided by the embodiments of the present disclosure will be described in detail below with reference to the accompanying drawings through some embodiments and application scenarios thereof

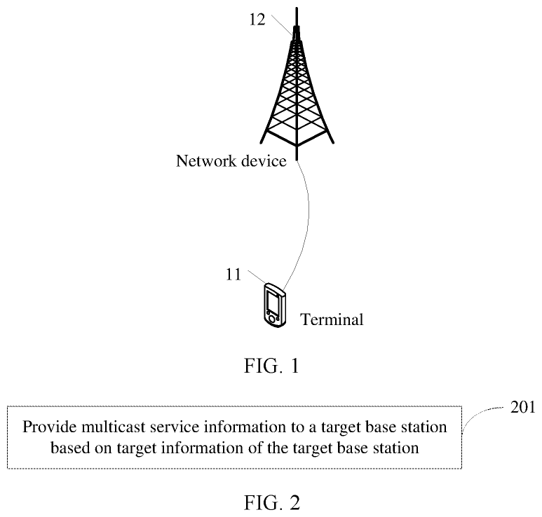

Please refer to FIG. 2. FIG. 2 is a flowchart of a handover processing method provided by an embodiment of the present disclosure. The method is performed by a source base station, as shown in FIG. 2, and includes the following steps:

Step 201: Provide multicast service information to a target base station based on target information of the target base station.

The target information includes at least one of the following: a base station type, supported service information, unsupported service information, or load information.

In the embodiments of the present disclosure, the source base station may be understood as a current serving base station of the terminal, and the target base station refers to a target base station to which the terminal is handed over during the handover process. For the cell handover procedure, the terminal may be handed over from the source cell to the target cell. The source base station may be understood as a network device in the source cell, and the above-mentioned target base station may also be understood as a network device in the target cell.

The multicast service information may be understood as: the multicast service being received by the terminal or the multicast service information corresponding to the multicast service that the terminal is interested in.

For example, in the process of receiving a multicast service by a certain terminal, when the source base station decides the handover operation of the terminal, the source base station can select the target base station, and can provide, based on the target information of the target base station, multicast service information for receiving the multicast service to the target base station. Therefore, the terminal can be assisted to establish the multicast service connection after handover to the target base station, so as to realize the continuity of the multicast service.

The manner in which the source base station selects the target base station may be set according to actual needs. For example, in an embodiment, the source base station selects the target base station based on a measurement report reported by the terminal or based on candidate cell information, or may independently select the target base station.

It should be understood that the target information of the target base station may be obtained by the source base station before handover, for example, obtained through interaction between the source base station and the target base station. Exemplarily, the source base station may interact with the target base station through an Xn interface to obtain target information of the target base station.

In the embodiments of the present disclosure, the multicast service information is provided to the target base station based on the target information of the target base station, so that the terminal can be assisted to establish the multicast service connection after switching to the target base station. Therefore, in the embodiments of the present disclosure, the continuity of the multicast service can be realized.

It should be noted that, the content included in the multicast service information may be set according to actual needs. For example, in an embodiment, the multicast service information includes a multicast service identity. The multicast service identity can be a Temporary Mobile Group Identity (TMGI) or a QoS flow identity (QFI).

Optionally, in an embodiment, the multicast service information may further include quality of service (QoS) requirement information corresponding to the multicast service identity.

Optionally, the base station types include a first type of base station and a second type of base station; where the first type of base station is a base station that can provide multicast services through multicast, and the second type of base station is a base station that cannot use multicast services. A base station that provides multicast services in broadcast mode.

In this embodiment, the first type of base station may be called a multicast base station, and the second type of base station may be called a traditional base station or a non-multicast base station. In this embodiment, the source base station should be understood as a multicast base station. The multicast manner can be understood as providing a multicast service by establishing a shared channel with a core network base station.

It should be understood that the target information is used to determine whether to send the multicast service information to the target base station. For different target information, the conditions for meeting the sending of multicast service information are also different. That is, in this embodiment of the present disclosure, the source base station may determine whether to provide multicast service information to the target base station in different manners based on different target information. For example, in an embodiment, the providing the multicast service information to the target base station based on the target information of the target base station includes at least one of the following:

in a case that the target information includes the base station type, and the base station type is a first type of base station, providing the multicast service information to the target base station, where the first type of base station is a base station that supports providing a multicast service in a multicast manner;

in a case that the target information includes the supported service information, and a service corresponding to the supported service information includes a target service, providing the multicast service information to the target base station;

in a case that the target information includes the unsupported service information, and a service corresponding to the unsupported service information does not include the target service, providing the multicast service information to the target base station; or in a case that the target information includes the load information, and it is determined based on the load information that radio resources of the target base station are sufficient to reserve air interface resources for the target service, providing the multicast service information to the target base station;

where the target service is a multicast service being received by the terminal or a multicast service that the terminal is interested in.

The load information may be understood as the load status of the target terminal, for example, may include the use status of the radio resources of the target base station, a number of users served by the target base station, and the like.

For the above base station types, if the target base station is a multicast base station, the source base station provides multicast service information to the target base station; if the target base station is a traditional base station, the source base station does not provide multicast service information to the target base station. That is, in a case that the target information includes the base station type, that the source base station provides multicast service information to the target base station needs to satisfy the first condition: the target base station is a multicast base station.

For the supported service information and the unsupported service information, in a case that the target information includes at least one of the supported service information or the unsupported service information, the source base station may determine, based on the target information, the target multicast service being received by the terminal or whether the target multicast service that the terminal is interested in is a multicast service supported by the target base station. If the target multicast service is a multicast service supported by the target base station, the source base station provides multicast service information to the target base station; if the target multicast service is a multicast service not supported by the target base station, the source base station does not provide multicast service information to the target base station. That is, in a case that the target information includes at least one of supported service information or unsupported service information, that the source base station provides multicast service information to the target base station needs to satisfy the second condition: the target multicast service being received by the terminal or the target multicast service that the terminal is interested in is the multicast service supported by the target base station.

As an example, the multicast service being received by the terminal is multicast service 1 and multicast service 2, where the multicast service 1 is a multicast service supported by the target base station, and the multicast service 2 is a multicast service not supported by the target base station, the source base station only provides the multicast service information corresponding to the multicast service supported by the target base station, that is, only provides the multicast service information corresponding to the multicast service 1.

For the load information, the source base station can determine, based on the load information, whether the radio resources of the target base station are sufficient to reserve air interface resources for the target multicast service received by the terminal from the source base station or the target multicast service that the terminal is interested in. If it is determined that the radio resources of the target base station are insufficient to reserve air interface resources for the target multicast service, the multicast service information is not provided to the target base station; if it is determined that the radio resources of the target base station are sufficient to reserve air interface resources for the target multicast service, multicast service information is provided to the target base station. That is, in a case that the target information includes load information, that the source base station provides multicast service information to the target base station needs to satisfy the third condition: the radio resources of the target base station are sufficient to reserve air interface resources for the target multicast service being received by the terminal or the target multicast service that the terminal is interested in.

As an example, the multicast service being received by the terminal is multicast service 1 and multicast service 2, and the radio resources of the target base station can only reserve air interface resources for one multicast service. In this case, the terminal only provides multicast service information corresponding to one multicast service, for example, the multicast service information corresponding to the multicast service 1 is provided. The source base station can arbitrarily choose one or more multicast services whose multicast service information is sent to the target base station, that is, the source base station can provide multicast service information corresponding to multicast service 1 to the target base station, and can also provide multicast service information corresponding to multicast services 2 to the target base station, and behavior of the source base station depends on the implementation of the base station. As another example, the source base station may determine, according to the QoS information corresponding to the multicast service, one or more pieces of multicast service information provided to the target base station. For example, the delay requirement corresponding to the multicast service 1 is lower than that of the multicast service 2. Therefore, the source base station provides multicast service information corresponding to the multicast service with a lower delay requirement to the target base station.

It should be noted that the terminal handover may include an Xn handover scenario and an N2 handover scenario, and for different handover scenarios, the corresponding manners in which the source base station provides multicast service information to the target base station are different.

For the Xn handover scenario, the source base station can directly provide multicast service information to the target base station.

For the N2 handover scenario, the source base station can provide multicast service information to the target base station through a core network device. That is, the providing the multicast service information to the target base station includes:

providing the multicast service information to the target base station through a core network device.

In order to better understand the implementation of the present disclosure, the following describes the handover process of the Xn handover scenario and the N2 handover scenario in detail.

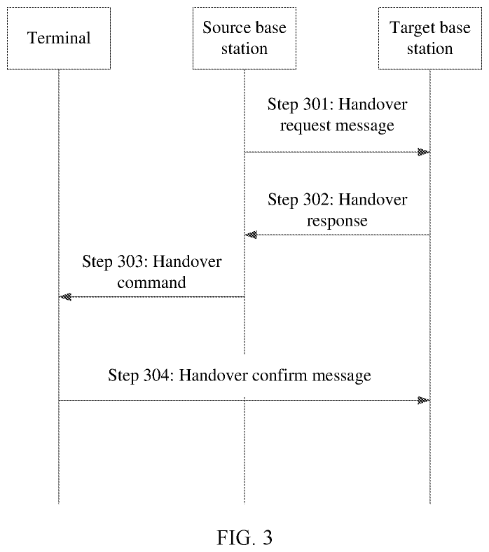

Embodiment 1: in the Xn handover scenario, it is assumed that the source base station is a multicast base station. As shown in FIG. 3, the handover process includes the following steps:

Step 301: The source base station decides to perform a handover operation, and after selecting a target base station, sends a handover request message to the target base station.

Optionally, the source base station determines, based on target information of the target base station, whether to carry multicast service information in the handover request message, where the multicast service information may include a multicast service identity and QoS requirement information related to the multicast service identity.

The target information of the target base station may be one or more of the following:

a base station type of the target base station, where the base station type includes a non-multicast base station and a multicast base station. The non-multicast base station refers to a base station that cannot provide a multicast service in a multicast manner. The multicast base station refers to a base station that can provide a multicast service in a multicast manner. Exemplarily, if the target base station is a multicast base station, the source base station carries, in the handover request message, the multicast service information corresponding to the multicast service. If the target base station is a traditional base station, the source base station does not carry, in the handover request message, the multicast service information corresponding to the multicast service.

Service information supported by the target base station or service information not supported by the target base station. Exemplarily, if the source base station determines that the multicast service being receive by the terminal from the source node or the multicast service that the terminal is interested in is a service that is not supported by the target base station, the source base station does not carry, in the handover request message, multicast service information corresponding to the multicast service. If the source base station determines that the multicast service being received by the terminal from the source node or the multicast service that the terminal is interested in is the service supported by the target base station, the source base station carries, in the handover request message, multicast service information corresponding to the multicast service.

The load status of the target base station, where the load status of the target base station includes the use status of the radio resources of the target base station, a number of users served by the target base station, and the like. Exemplarily, if the source base station determines that the radio resources of the target base station are insufficient to reserve air interface resources for the multicast service received by the terminal from the source base station or the multicast service that the terminal is interested in, the source base station does not carry, in the handover request message, the multicast service information corresponding to the multicast service. If the source base station determines that the radio resources of the target base station are sufficient to reserve air interface resources for the multicast service received by the terminal from the source base station or the multicast service that the terminal is interested in, the source base station carries, in the handover request message, the multicast service information corresponding to the multicast service.

It should be noted that, the target information of the target base station may be obtained by the source base station through interaction with the target base station before handover, such as through the Xn interface.

Step 302: The target base station receives a handover request message, and sends a handover response message (for example, handover response) to a source node.

Step 303: The source base station sends a handover command to the terminal.

Step 304: The terminal establishes a connection with the target base station, and after accessing the target base station, sends a handover confirmation message, such as a handover confirm message, to the target base station.

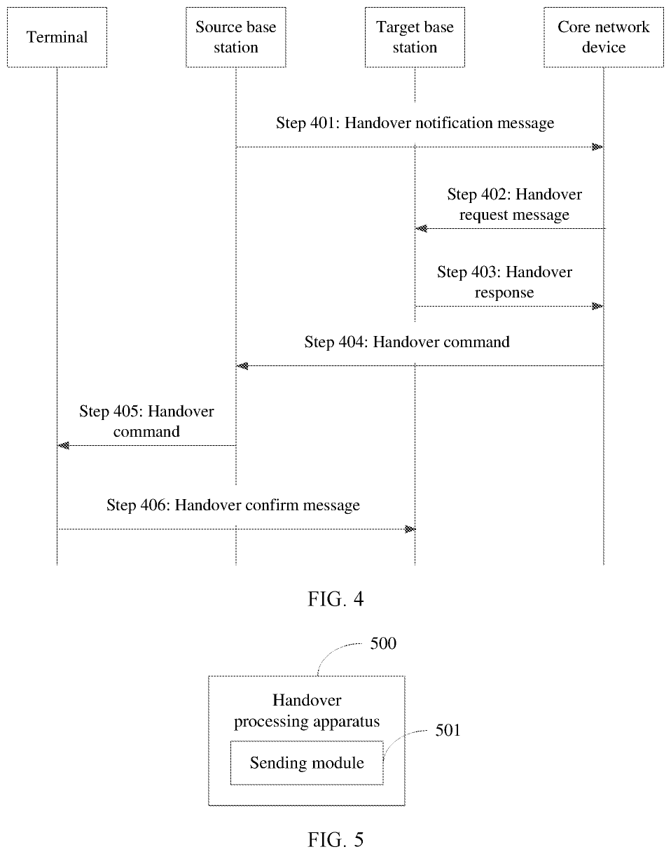

Embodiment 2: in an N2 handover scenario, it is assumed that the source base station is a multicast base station. As shown in FIG. 4, the handover process includes the following steps:

Step 401: The source base station determines to perform a handover operation, and after selecting the target base station, sends a handover notification (Holdover Required)message to a core network device.

Optionally, the source base station determines, based on target information of the target base station, whether to carry multicast service information in the handover request message, where the multicast service information may include a multicast service identity and QoS requirement information related to the multicast service identity.

The target information of the target base station may be one or more of the following:

a base station type of the target base station, where the base station type includes a non-multicast base station and a multicast base station. The non-multicast base station refers to a base station that cannot provide a multicast service in a multicast manner. The multicast base station refers to a base station that can provide a multicast service in a multicast manner. Exemplarily, if the target base station is a multicast base station, the source base station carries, in the handover notification message, the multicast service information corresponding to the multicast service. If the target base station is a traditional base station, the source base station does not carry, in the handover notification message, the multicast service information corresponding to the multicast service.

Service information supported by the target base station or service information not supported by the target base station. Exemplarily, if the source base station determines that the multicast service being receive by the terminal from the source node or the multicast service that the terminal is interested in is a service that is not supported by the target base station, the source base station does not carry, in the handover notification message, multicast service information corresponding to the multicast service. If the source base station determines that the multicast service being received by the terminal from the source node or the multicast service that the terminal is interested in is the service supported by the target base station, the source base station carries, in the handover notification message, multicast service information corresponding to the multicast service.

The load status of the target base station, where the load status of the target base station includes the use status of the radio resources of the target base station, a number of users served by the target base station, and the like. Exemplarily, if the source base station determines that the radio resources of the target base station are insufficient to reserve air interface resources for the multicast service received by the terminal from the source base station or the multicast service that the terminal is interested in, the source base station does not carry, in the handover notification message, the multicast service information corresponding to the multicast service. If the source base station determines that the radio resources of the target base station are sufficient to reserve air interface resources for the multicast service received by the terminal from the source base station or the multicast service that the terminal is interested in, the source base station carries, in the handover notification message, the multicast service information corresponding to the multicast service.

Step 402: The core network device (for example, a network function entity) sends a handover request message to the target base station, where the message carries information in the handover notification message. For example, multicast service information may be included, and the multicast service information may include a multicast service identity and QoS information related to the multicast service identity. Exemplarily, if the handover notification message received by the core network device includes multicast service information, the core network device carries the multicast service information in the handover request message.

Step 403: The target base station returns a handover response, such as a handover response message, to the core network device.

Step 404: The core network device sends a handover command, such as a handover command message, to the source base station.

Step 405: The source base station sends a handover command to the user terminal UE.

Step 406: After the UE accesses the target base station, the UE sends a handover confirmation message, such as a handover confirm message, to the target base station.

The handover processing method provided by the embodiments of the present disclosure may be performed by a handover processing apparatus or a control module included in the handover processing apparatus and configured to execute the handover processing method. In an embodiment of the application, the handover processing apparatus provided in the embodiments of the application is described by using an example in which the handover processing method is performed by a handover processing apparatus.

Please refer to FIG. 5. FIG. 5 is a structural diagram of a handover processing apparatus provided by an embodiment of the present disclosure. As shown in FIG. 5, the handover processing apparatus 500 includes:

a sending module 501, configured to provide multicast service information to a target base station based on target information of the target base station;

where the target information includes at least one of the following: a base station type, supported service information, unsupported service information, or load information.

Optionally, the multicast service information includes a multicast service identity.

Optionally, the multicast service information further includes QoS requirement information corresponding to the multicast service identity.

Optionally, the base station type includes a first type of base station and a second type of base station, the first type of base station is a base station that supports providing a multicast service in a multicast manner, and the second type of base station is a base station that does not support providing a multicast service in a multicast manner.

Optionally, the sending module 501 is configured to:

provide the multicast service information to the target base station through a core network device.

Optionally, the sending module 501 is configured to perform at least one of the following:

in a case that the target information includes the base station type, and the base station type is a first type of base station, providing the multicast service information to the target base station, where the first type of base station is a base station that supports providing a multicast service in a multicast manner;

in a case that the target information includes the supported service information, and a service corresponding to the supported service information includes a target service, providing the multicast service information to the target base station;

in a case that the target information includes the unsupported service information, and a service corresponding to the unsupported service information does not include the target service, providing the multicast service information to the target base station; or in a case that the target information includes the load information, and it is determined based on the load information that radio resources of the target base station are sufficient to reserve air interface resources for the target service, providing the multicast service information to the target base station;

where the target service is a multicast service being received by the terminal or a multicast service that the terminal is interested in.

The network device provided in this embodiment of the application can implement the processes in the foregoing method embodiment in FIG. 2. To avoid repetition, details are not described herein again.

The handover processing apparatus in this embodiment of the present disclosure may be an apparatus, or a component, an integrated circuit, or a chip in a terminal. The apparatus may be a mobile terminal, or a non-mobile terminal. For example, the mobile terminal may include but is not limited to the foregoing listed types of terminals 11. The non-mobile terminal may be a server, a network attached storage (NAS), a personal computer (PC), a television (TV), a teller machine, or a self-service machine. This is not limited in this embodiment of the present disclosure.

The handover processing apparatus in this embodiment of the present disclosure may be an apparatus with an operating system. The operating system may be an Android operating system, an iOS operating system, or another possible operating system, which is not limited in the embodiments of the present disclosure.

The handover processing apparatus provided by the embodiment of the application can realize each process of the method embodiment of FIG. 2, and achieve the same technical effect. To avoid repetition, it will not be repeated herein.

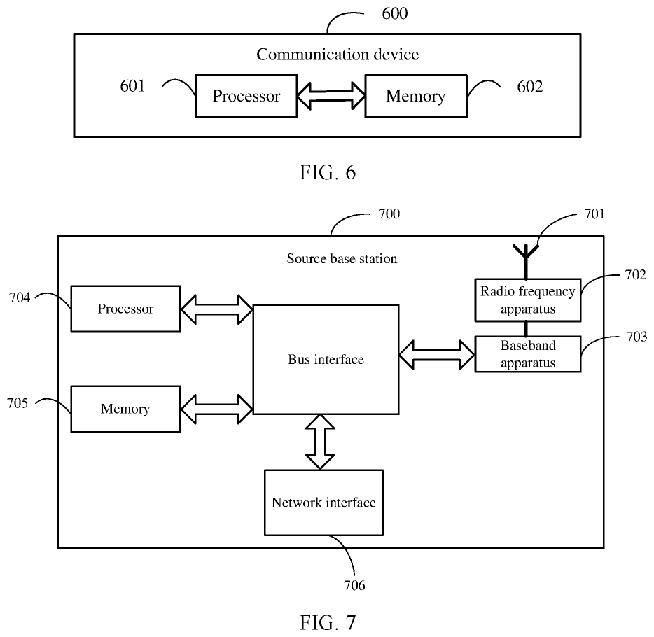

Optionally, as shown in FIG. 6, the embodiments of the present disclosure further provide a communication device 600, including a processor 601, a memory 602, and programs or instructions stored in the memory 602 and executable on the processor 601. When the programs or instructions are executed by the processor 601, the processes of the foregoing embodiment of the handover processing method are implemented, and a same technical effect can be achieved. To avoid repetition, details are not described herein again.

Illustratively, an embodiment of the present disclosure further provides a source base station. As shown in FIG. 7, the network device 700 includes an antenna 701, a radio frequency apparatus 702, and a baseband apparatus 703. The antenna 701 is connected to the radio frequency apparatus 702. In an uplink direction, the radio frequency apparatus 702 receives information by using the antenna 701, and sends the received information to the baseband apparatus 703 for processing. In a downlink direction, the baseband apparatus 703 processes to-be-sent information, and sends the to-be-sent information to the radio frequency apparatus 702. After processing the received information, the radio frequency apparatus 702 sends the information by using the antenna 701.

The foregoing band processing apparatus may be located in the baseband apparatus 703, and the method performed by the source base station in the foregoing embodiment may be implemented in the baseband apparatus 703. The baseband apparatus 703 includes a processor 704 and a memory 705.

The baseband apparatus 703 may include, for example, at least one baseband board, where a plurality of chips are disposed on the baseband board. As shown in FIG. 7, one chip is, for example, the processor 704, which is connected to the memory 705, so as to invoke a program in the memory 705 to perform operations of the network device shown in the foregoing method embodiment.

The baseband apparatus 703 may further include a network interface 706, configured to exchange information with the radio frequency apparatus 702. For example, the interface is a common public radio interface (CPRI).

Illustratively, the source base station in this embodiment of the present disclosure further includes programs or instructions stored in the memory 705 and executable on the processor 704, and the processor 704 invokes the programs or instructions in the memory 705 to perform the method performed by the modules show in FIG. 5, and achieve the same technical effect. In order to avoid repetition, it will not be repeated herein.

An embodiment of the present disclosure further provides a non-transitory readable storage medium. The non-transitory readable storage medium stores programs or instructions. When the programs or instructions are executed by a processor, the processes of the foregoing embodiment of the handover processing method are implemented, and a same technical effect can be achieved. To avoid repetition, details are not described herein again.

The processor is a processor in the source base station in the foregoing embodiment. The non-transitory readable storage medium includes a non-transitory computer-readable storage medium such as a read-only memory (ROM), a random access memory (RAM), a magnetic disk, an optical disc, or the like.

An embodiment of the present disclosure further provides a chip, where the chip includes a processor and a communication interface, the communication interface is coupled to the processor, and the processor is configured to execute a program or an instruction of a network device to implement the foregoing processes of the foregoing embodiment of the handover processing method, and a same technical effect can be achieved. To avoid repetition, details are not described herein again.

It should be understood that the chip mentioned in this embodiment of the present disclosure may also be referred to as a system-level chip, a system chip, a chip system, or an on-chip system chip.

An embodiment of the present disclosure further provides a computer program product. The computer program product is executed by at least one processor to implement processes of the foregoing embodiment of the foregoing handover processing method, and a same technical effect can be achieved. To avoid repetition, details are not described herein again.

An embodiment of the present disclosure also provides a source base station, configured to perform each process of the foregoing embodiment of the handover processing method, and can achieve the same technical effect. To avoid repetition, details are not repeated herein.

It should be noted that, in this specification, the terms “include”, “comprise”, or their any other variant is intended to cover a non-exclusive inclusion, so that a process, a method, an article, or an apparatus that includes a list of elements not only includes those elements but also includes other elements which are not expressly listed, or further includes elements inherent to such process, method, article, or apparatus. Without further restrictions, the element defined by the statement “including a . . . ” does not exclude the existence of another identical element in the process, method, article or apparatus including the element.

In addition, it should be noted that the scope of the method and the apparatus in the embodiments of the present disclosure is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the descriptions of the foregoing implementation manners, a person skilled in the art may clearly understand that the method in the foregoing embodiment may be implemented by software in addition to a necessary universal hardware platform or by hardware only. In most circumstances, the former is a preferred implementation manner. Based on such an understanding, the technical solutions of the present disclosure essentially, or the part contributing to the prior art may be implemented in a form of a software product. The software product is stored in a storage medium (for example, ROM/RAM, a magnetic disk, or an optical disc), and includes several instructions for instructing a terminal (which may be a mobile phone, a computer, a server, an air conditioner, a base station, or the like) to perform the method described in the embodiments of the present disclosure.

The embodiments of the present disclosure are described above with reference to the accompanying drawings, but the present disclosure is not limited to the foregoing implementation manners. The foregoing implementation manners are merely schematic instead of restrictive. Under enlightenment of the present disclosure, a person of ordinary skills in the art may make many forms without departing from aims and the protection scope of claims of the present disclosure, all of which fall within the protection scope of the present disclosure.

What is claimed is:

1. A handover processing method, performed by a source base station and comprising:
providing multicast service information to a target base station based on target information of the target base station; wherein
the target information comprises at least one of following: a base station type, supported service information, unsupported service information, or load information.

2. The method according to claim 1, wherein the multicast service information comprises a multicast service identity.

3. The method according to claim 2, wherein the multicast service information further comprises quality of service (QoS) requirement information corresponding to the multicast service identity.

4. The method according to claim 1, wherein the base station type comprises a first type of base station and a second type of base station; wherein
the first type of base station is a base station that supports providing a multicast service in a multicast manner, and the second type of base station is a base station that does not support providing a multicast service in a multicast manner.

5. The method according to claim 1, wherein the providing the multicast service information to the target base station comprises:
providing the multicast service information to the target base station through a core network device.

6. The method according to claim 1, wherein the providing the multicast service information to the target base station based on the target information of the target base station comprises at least one of following:
in a case that the target information comprises the base station type, and the base station type is a first type of base station, providing the multicast service information to the target base station; wherein
the first type of base station is a base station that supports providing a multicast service in a multicast manner;
in a case that the target information comprises the supported service information, and a service corresponding to the supported service information comprises a target service, providing the multicast service information to the target base station;
in a case that the target information comprises the unsupported service information, and a service corresponding to the unsupported service information does not comprise the target service, providing the multicast service information to the target base station; or in a case that the target information comprises the load information, and it is determined based on the load information that radio resources of the target base station are sufficient to reserve air interface resources for the target service, providing the multicast service information to the target base station; wherein
the target service is a multicast service being received by a terminal or a multicast service that the terminal is interested in.

7. A source base station, comprising a memory, a processor, and programs or instructions stored in the memory and executable on the processor, wherein the programs or the instructions, when executed by the processor, causes the source base station to perform:
providing multicast service information to a target base station based on target information of the target base station; wherein
the target information comprises at least one of following: a base station type, supported service information, unsupported service information, or load information.

8. The source base station according to claim 7, wherein the multicast service information comprises a multicast service identity.

9. The source base station according to claim 8, wherein the multicast service information further comprises quality of service (QoS) requirement information corresponding to the multicast service identity.

10. The source base station according to claim 7, wherein the base station type comprises a first type of base station and a second type of base station; wherein
the first type of base station is a base station that supports providing a multicast service in a multicast manner, and the second type of base station is a base station that does not support providing a multicast service in a multicast manner.

11. The source base station according to claim 7, wherein the programs or the instructions, when executed by the processor, causes the source base station to perform:
providing the multicast service information to the target base station through a core network device.

12. The source base station according to claim 7, wherein the programs or the instructions, when executed by the processor, causes the source base station to perform at least one of following:
in a case that the target information comprises the base station type, and the base station type is a first type of base station, providing the multicast service information to the target base station; wherein
the first type of base station is a base station that supports providing a multicast service in a multicast manner;
in a case that the target information comprises the supported service information, and a service corresponding to the supported service information comprises a target service, providing the multicast service information to the target base station;
in a case that the target information comprises the unsupported service information, and a service corresponding to the unsupported service information does not comprise the target service, providing the multicast service information to the target base station; or in a case that the target information comprises the load information, and it is determined based on the load information that radio resources of the target base station are sufficient to reserve air interface resources for the target service, providing the multicast service information to the target base station; wherein
the target service is a multicast service being received by a terminal or a multicast service that the terminal is interested in.

13. A non-transitory readable storage medium, wherein the non-transitory readable storage medium stores programs or instructions, and the programs or the instructions, when executed by a processor of a source base station, causes the source base station to perform:
providing multicast service information to a target base station based on target information of the target base station; wherein
the target information comprises at least one of following: a base station type, supported service information, unsupported service information, or load information.

14. The non-transitory readable storage medium according to claim 13, wherein the multicast service information comprises a multicast service identity.

15. The non-transitory readable storage medium according to claim 14, wherein the multicast service information further comprises quality of service (QoS) requirement information corresponding to the multicast service identity.

16. The non-transitory readable storage medium according to claim 13, wherein the base station type comprises a first type of base station and a second type of base station; wherein
the first type of base station is a base station that supports providing a multicast service in a multicast manner, and the second type of base station is a base station that does not support providing a multicast service in a multicast manner.

17. The non-transitory readable storage medium according to claim 13, wherein the programs or the instructions, when executed by the processor of the source base station, causes the source base station to perform:
providing the multicast service information to the target base station through a core network device.

18. The non-transitory readable storage medium according to claim 13, wherein the programs or the instructions, when executed by the processor of the source base station, causes the source base station to perform at least one of following:
in a case that the target information comprises the base station type, and the base station type is a first type of base station, providing the multicast service information to the target base station; wherein
the first type of base station is a base station that supports providing a multicast service in a multicast manner;
in a case that the target information comprises the supported service information, and a service corresponding to the supported service information comprises a target service, providing the multicast service information to the target base station;
in a case that the target information comprises the unsupported service information, and a service corresponding to the unsupported service information does not comprise the target service, providing the multicast service information to the target base station; or
in a case that the target information comprises the load information, and it is determined based on the load information that radio resources of the target base station are sufficient to reserve air interface resources for the target service, providing the multicast service information to the target base station; wherein the target service is a multicast service being received by a terminal or a multicast service that the terminal is interested in.

19. A chip, comprising a processor and a communications interface, wherein the communications interface is coupled with the processor, and the processor is configured to execute programs or instructions to implement the handover processing method according to claim 1.

20. A computer program product, wherein the computer program product is executed by at least one processor to implement the handover processing method according to claim 1.
